(19) United States
(12) Patent Application Publication
(10) Pub. No.: US 2024/0366032 A1
(43) Pub. Date: Nov. 7, 2024

(54) Blender enclosure

(71) Applicant: Paul Howard Nye, Redmond, WA (US)

(72) Inventor: Paul Howard Nye, Redmond, WA (US)

(21) Appl. No.: 18/142,990

(22) Filed: May 3, 2023

(51) Int. Cl. A47J 43/07

(52) U.S. Cl. CPC A47J 43/0772; A47J 43/0716; G10K 11/16

(57) ABSTRACT

This invention relates to an enclosure such as those which house a food processor to deaden the noise emanating there from. An enclosure for a food blender including an enclosure base portion into which a food blender mechanism is placed, enclosure side walls attached to the base, and a top cover portion attachable to the side walls portion. The enclosure base portion includes a bottom, sides, front, back walls and open on the top. The main side walls portion includes front, back, sides, and open ends. The top cover includes a seal against the side walls and a center recess into which fits a blender food canister and through which the user can grip via top cover flexible material.

### CROSS-REFERENCE TO RELATED APPLICATION

This application claims the benefit of U.S. Provisional application 63/340,286, filed on May 10, 2022.

### FIELD OF THE INVENTION

The present invention relates primarily to a food blender enclosure to reduce the noise emanating therefrom and more particularly it relates to a food blender enclosure having an enclosure base, side wall attached to the enclosure base and top cove attached to the top of the side walls to provide a sound reducing sealed enclosure between enclosure base, side walls and top cover.

### BACKGROUND OF THE INVENTION

This invention relates to a food blender enclosure to reduce the noise emanating there-from. This invention relates to such an enclosure having an enclosure base, side walls attached to the enclosure base and a top cover attached to the top of the side walls to provide a sound reducing sealed enclosure between enclosure base, side walls and top cover.

Common food blenders consist of a high speed motor in a bender base. Mounted on top of the base is a mixing and chopping food canister. Blenders create very high levels of noise generated by the high speed mixing of food materials in the food canister, from high speed cooling air being drawn in and exiting the electric blender motor and sound generated from the vibration of the motor. Blender noise is significantly disturbing in office and home environments.

Enclosures for blenders to reduce noise are common and well known in the art. Some provide for a split cover which encloses the blender food canister and attaches to the top of a blender base leaving blender controls exposed. This enclosure reduces noise generated by the food canister but the blender base and motor which also generate noise are left exposed to the environment. Other solutions provide for enclosing both the food canister and blender motor. In so doing the controls for the blender are also covered which requires the user to start the blender before the cover can be closed thus exposing the user for some period of time to very high noise levels.

Many of these enclosures consist of a fixed portion of a cover and a hinged portion of a cover. These designs rely on close fitment between surfaces of these covers to control noise. These covers are large, molded parts where part dimension and distortions are difficult to control resulting in sound leaks and underperformance of the enclosure.

In addition to blenders with front panel controls a class of blenders often referred to as bullet or personal blenders have no front panel controls. The blender is started and stopped by inserting and removing a food canister assembly. This assembly consists of a food canister with a threaded open end and a bottom base with integrated rotating mixing and cutting knives. Materials to be mixed are placed in the food canister which then has the bottom base threaded into place creating a tight seal. When this canister assembly is placed into the bullet blender the blender motor will start. Some of these bullet blenders require the user to continuously place downward pressure on the canister to hold it in place to keep the blender motor operating while others have a depress and lock function to keep the motor running without user intervention. Since the canister assembly is completely sealed there is a potential for the contents to heat up and expand from blending knife friction creating pressures that can cause the enclosure to fail expelling potentially hot contents on the user and in some cases bring the users hands into contact with rotating knives. Conventional blenders with food canisters with press fit top covers do not present this danger since the top can loosen as pressure builds thus minimizing violent explosions and container failure.

Food blenders are manufactured with a single decorative enclosure which cannot be changed by the user to reflect other home decoration styles or reflect interest in sports teams or automobile brands or generally in interests the user may wish to reflect in decorating home appliances including the food blender.

Thus, the need exists for an enclosure for a food processor which is effective at significantly reducing noise levels created by operation of the food processor and protecting users from food canister failures in addition to allowing the user to change the decorative appearance of the blender.

### BRIEF SUMMARY OF THE INVENTION

It is thus an object of one aspect of the present invention to provide a sealed soundproof enclosure for a stand-alone food blender that reduces the noise level of the food blender during operation.

It is an object of another aspect of the present invention to provide an enclosure, as above, that provides a means to turn blender power on and off without breaking the soundproof seals of the enclosure.

It is an object of another aspect of the present invention to provide a safety enclosure around the entire stand-alone blender to protect the user from unexpectedly coming in contact with blender contents or with blender cutting knives.

It is an object of another aspect of the present invention to integrate blender components with sound enclosure components to form a single integrated soundproof blender assembly.

It is an object of another aspect of the present invention to integrate panels that wrap around the enclosure base or enclosure side walls offering decoration and additional mass to reduce sound levels.

It is an object of another aspect of the present invention to attach a separate battery pack and lighting assembly capable of powering the blender without connection to main AC power and in addition providing light sources which couple to the blender side covers to provide area lighting and decorative effect.

These and other objects of the present invention, as well as the advantages thereof over existing prior art forms, which will become apparent from the description to follow, are accomplished by the improvements hereinafter described and claimed.

In general, an enclosure for a food blender according to the concepts of the present invention includes a base portion, which is of sufficient mass as to reduce sound vibrations passing through and into which the blender assembly is set. The blender power cord is routed through a rear gromet opening. Attached to the base is an enclosure cover which is of sufficient mass as to reduce sound vibrations passing through. On the upper top edge of the enclosure side walls is a top cover which seals the entire assembly, is of sufficient mass as to reduce sound vibrations passing through but also is flexible allowing the user to grasp and manipulate the food canister portion of the enclosed blender assembly.

In accordance with at least one aspect of the present invention, an enclosure for a food blender is integrated with blender mechanisms to form a single integrated soundproof blender assembly eliminating the sand-alone blender enclosure in previous embodiments.

A preferred exemplary enclosure for a food processor according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 is a perspective view of a blender enclosure.

FIG. 2A is a perspective view of the blender enclosure of FIG. 1 with the top cover exploded.

FIG. 2B is a perspective view of a representative bullet type blender

FIG. 3 is a cross section view of the blender enclosure of FIG. 1.

FIG. 4A is a perspective view of an enclosure base for the blender enclosure shown in FIG. 1.

FIG. 4B is a blown up view of the power cord being inserted in base.

FIG. 4C is a blown up view of the power cord fully inserted into base.

FIG. 5 is a perspective view of the side walls portion of the blender enclosure shown in FIG. 1.

FIG. 6A is a perspective view of a top cover of the blender enclosure shown in FIG. 1.

FIG. 6B is a cross section video of top cover of FIG. 6A showing fit up with the food canister.

FIG. 6C is a cross section view of alternate top cover showing fit up with the enclosure side wall.

FIG. 7 is a perspective view of a blender fully enclosed by enclosure base, side walls and top cover for blender cover shown in FIG. 1.

FIG. 8 is an exploded view of FIG. 7 illustrating the blender food cup assembly being removed with blender top cover attached.

FIG. 9 is a cross section exploded view of FIG. 8 illustrating the blender food cup assembly being removed with blender top cover attached.

FIG. 10A Illustrates the interference fit between the top cover and food canister.

FIG. 10B illustrates the interference fit between the top cover and side wall top edge.

FIG. 10C is a cross section view of FIG. 7 illustrating the blender food cup assembly installed in the blender motor base assembly.

FIG. 11A is a perspective view of a blender assembly and blender enclosure.

FIG. 11B is a perspective view of single unit assembly showing bottom structures

FIG. 11C is a blow up of the bottom gromet structures of the single unit assembly.

FIG. 12A is a perspective view of a blender assembly and blender enclosure

FIG. 12B is a cross section of FIG. 12A.

FIG. 12C is an exploded view of FIG. 12B with blender food canister assembly and top cover separate from main assembly.

FIG. 12D is a perspective view of the blender food canister assembly and top cover.

FIG. 13A an alternative assembly of FIG. 12A utilizing a alternative gasket configuration.

FIG. 13B is a cross section of the double wall blender food canister in FIG. 13C.

FIG. 13C is a cross section of a double walled assembly.

FIG. 13D is a blown up section of 13C showing details of gasket interference.

FIG. 14A illustrates a sound enclosure that integrates a blender mechanism.

FIG. 14B Is a cross section of the blender integrated sound enclosure.

FIG. 14C Is the rear view of the blender integrated sound enclosure.

FIG. 14D Is a cross section showing slot for decorative wrap and electrical contacts.

FIG. 15A illustrates the application of a decorative wrap

FIG. 15B is a rear view showing how the decorative wrap fits into rear slot and the structure of the decorative wrap

FIG. 15C is a rendered example of a blender integrated sound enclosure with decorative wrap.

FIG. 15D is a rendered example of a blender integrated sound enclosure with decorative wrap.

FIG. 16A Illustrates shorter enclosure base exposing more blender cup

FIG. 16B is a cross section of FIG. 16A

FIG. 16C illustrates the enclosure base the full height of the blender assembly

FIG. 16D is a cross section of FIG16C illustrating a tilt up cover

FIG. 17A is a cross section of blender and enclosure assembly with fin shaped sound baffles

FIG. 17B is a cross section of blender and enclosure assembly with hat shaped sound baffles

FIG. 18 is a cross section of blender and enclosure assembly with hat shaped sound baffles with a perforated cover

FIG. 19A is an exploded view of integrated sides and base with battery power unit.

FIG. 19B is an assembled rear view of integrated sides and base with battery power unit.

FIG. 20A is a front view of the battery power unit

FIG. 20B is a vertical cross section of the battery power unit

FIG. 20C is a horizontal cross section of the battery power unit.

FIG. 20D is a top view of the battery power unit.

### DETAILED DESCRIPTION OF THE INVENTION

The inventors provide a unique system for reducing the sound levels and adding a safety enclosure to food blenders. The present invention is described in enabling detail in the following examples, which may represent more than one embodiment of the present invention.

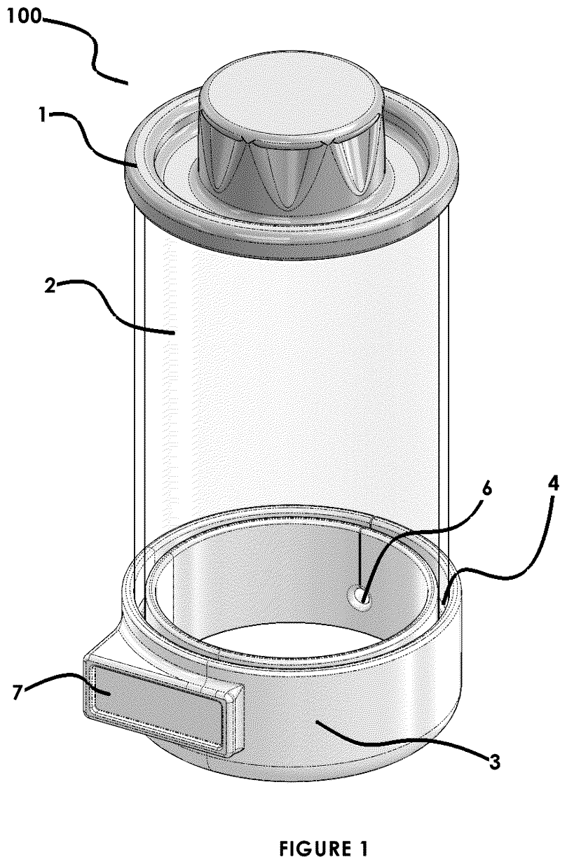

One embodiment of an enclosure for a food processor made in accordance with the present invention is shown in FIGS. 1-10 and indicated generally by the numeral 100. In this example the food processor includes a base member, generally indicated by the numeral 16, which houses a motor to operate the blender.

FIG. 1 Enclosure embodiment 100 includes a top cover 1, a side walls 2 and an enclosure base 3. A side walls 2 are inserted into an enclosure base slot 4. A nameplate recess 7 is a flat surface suitable for attaching product identification for example name plate, decal, screen, or pad printing. A blender AC power cord pass through 6 an opening in enclosure base 3 through which blender AC power cord 48 may pass.

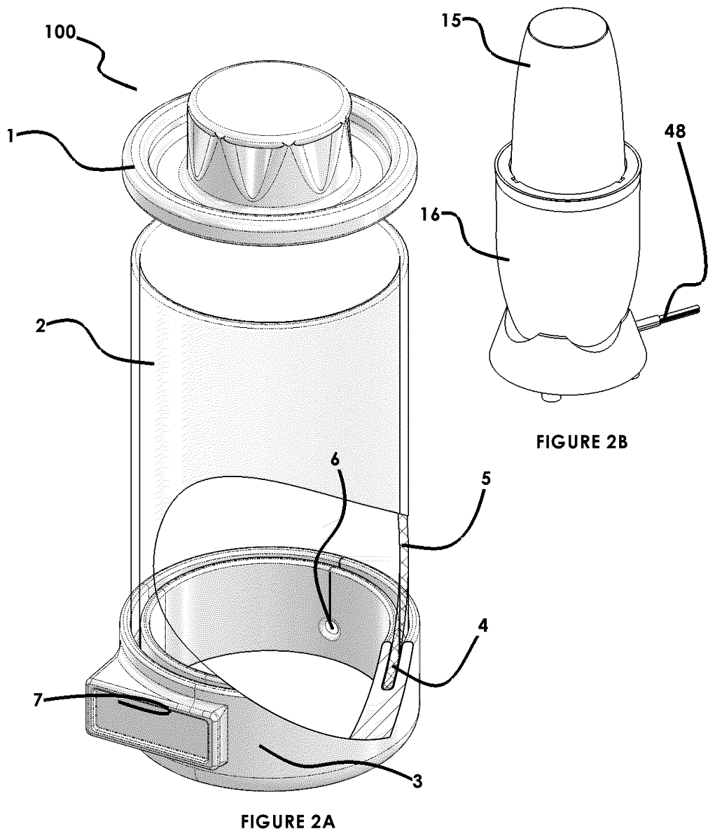

FIG. 2A Illustrates an enclosure side wall cross section 5 showing an example of side wall 2 attachment to enclosure base 3. FIG. 2B illustrates bullet type blender comprising a food canister 15 holding materials to be blended and a blender base 16 containing the blender motor with blender AC power cord 48. Inserting food canister 15 into blender base 16 turns on the blender motor.

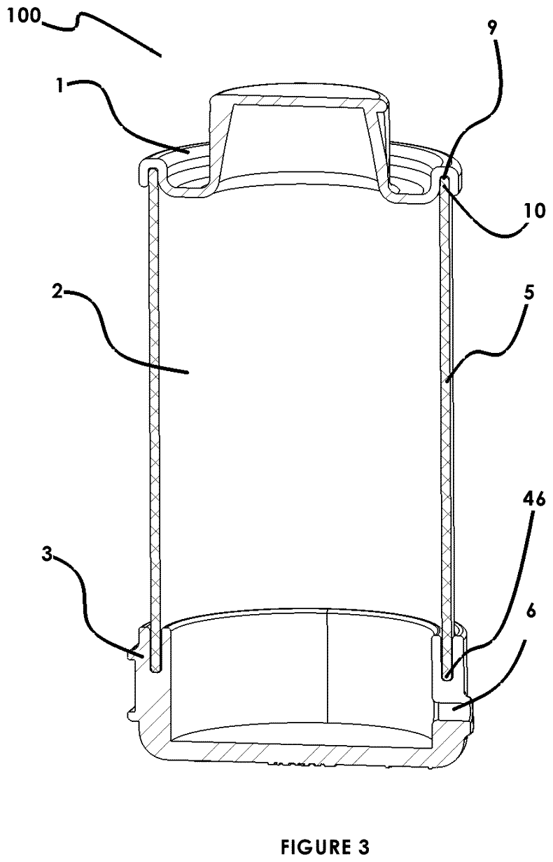

FIG. 3 Illustrates a top cover edge groove 9 which seals against a side wall top edge 10 of side wall 2 minimizing the movement of air between the enclosure interior and enclosure exterior and reducing sound to which user is exposed.

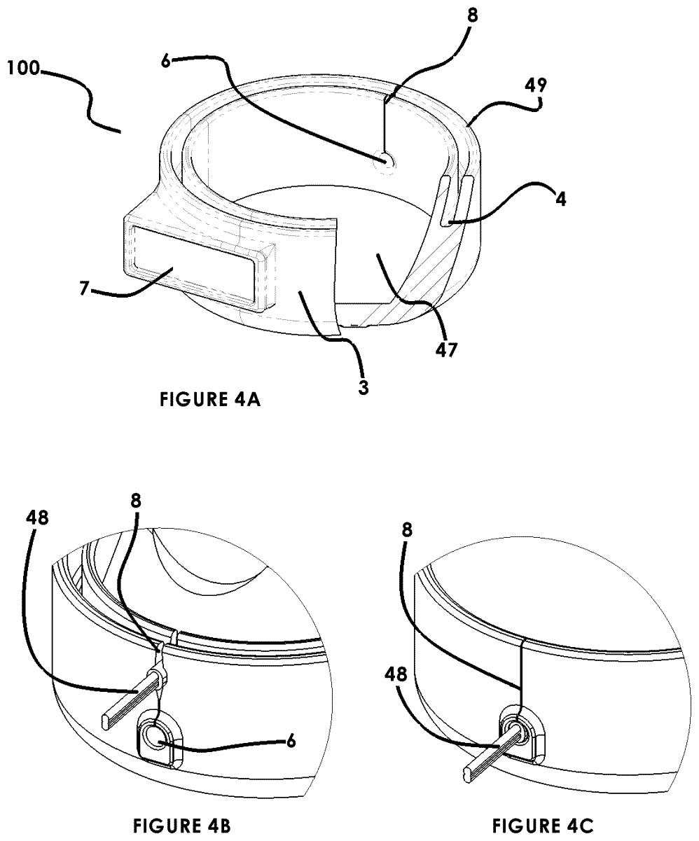

FIG. 4A an example of enclosure base 3 molded in for example high density foam, silicone, rubber, or plastic offering additional vibration and sound absorption for enclosure 100. A nameplate recess 7 is shown. An enclosure base slot 4 can receive the side wall bottom edge 46. In this example the width of the base slot 4 widens as the side wall bottom edge 46 is received enabling an air and noise seal. FIG. 4B illustrates a cord relief slot 8 being spread open as the blender base power cord 48 is being pressed in a downward direction from the enclosure base top edge 49 into the blender AC power cord pass through 6. For example, the flexibility of high density foam or silicone used to mold the enclosure base 3 enables cord relief slot 8 to spread accommodating blender power cord 48 and once blender power cord 48 is captured by blender AC power cord pass through 6 cord relief slot 8 will return to a closed position as shown in FIG. 4C enhancing the air and noise seal.

When side wall 2 is for example positioned down enclosure base slot 4 after blender power cord 48 has been captured by blender AC power cord pass through 6 via cord relief slot 8 it will seal noise loss through cord relief slot 8.

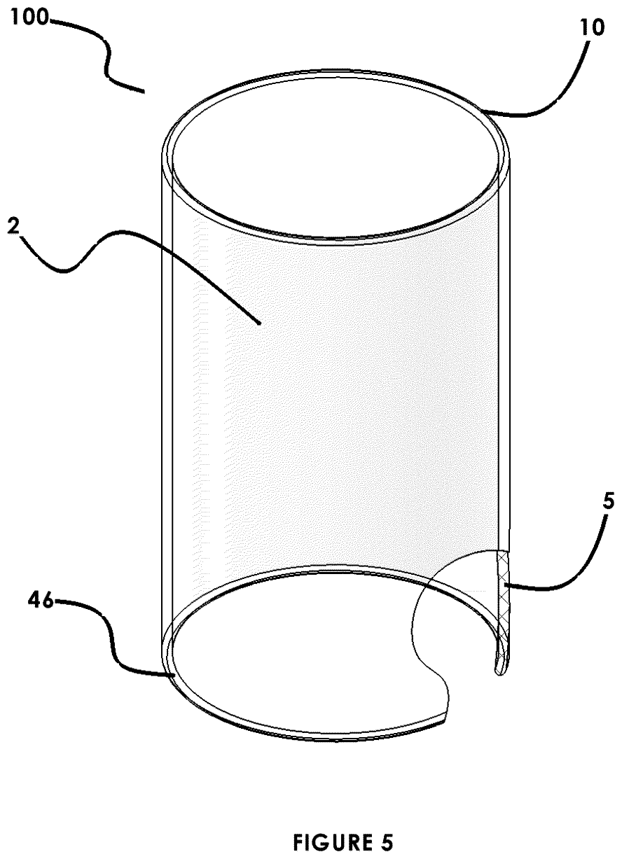

FIG. 5 Enclosure assembly 100 sound reduction effectiveness increases as enclosure side wall 5 cross section increases. The preferred embodiment thickness is from 4 to 8 mm of for instance acrylic, polycarbonate, or dense material whose molding processes comprise injection molding, extrusion, casting, or compression molding. A side wall top edge 10 and a side wall bottom edge 46 of side wall 2 are rounded or beveled to enhance sealing efficiency between enclosure top cover 1 and enclosure base 3. Through convection the large surface area of the side wall 2 efficiently transfers heat generated from the electric motor 26 motor through the side walls. In addition to the preferred embodiment of a single thickness side wall, two or more layers of material with air gaps between layers can offer additional sound damping.

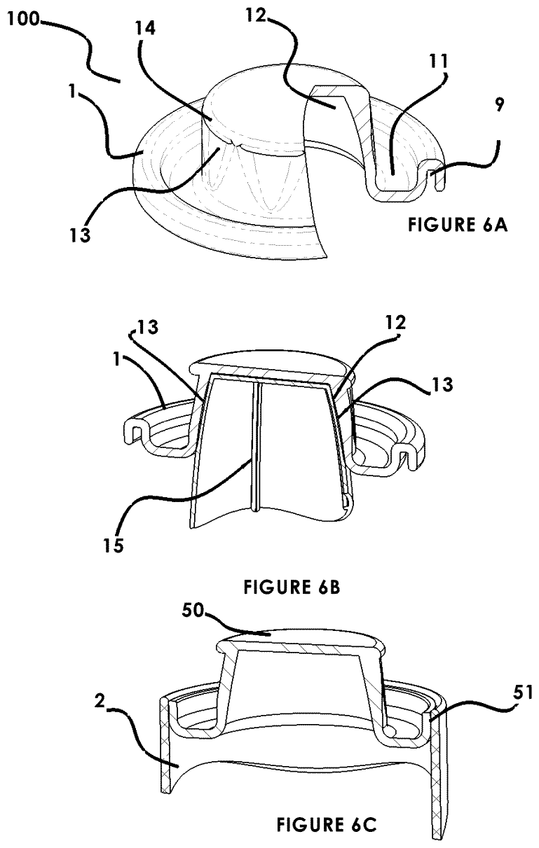

FIG. 6A The preferred embodiment of enclosure top cover 1 is molded from silicone or other flexible materials. The top and side walls of top cover edge groove 9 seal against the side wall top edge 10, inside and outside walls of the enclosure side wall 2.

FIG. 6B illustrates the inside center surface of the enclosure top cover center section 12 stretches over the end of the blender food canister 15 which allows the user to grip the canister through the flexible material for efficient insertion and removal in addition to pressing the food canister 15 down into the blender base 16 to start the blender motor. In this example as user presses on and squeezes food canister 15 through top cover center section 12, top cover canister grip surface 13, top cover lip 14, the top cover edge groove 9 grips and seals top edge of side walls 10 top cover valley 11 material will stretch allowing center section to rotate and depress starting blender. In this example to stop blender motor, rotate counter direction remove canister disengaging blender electric motor 26 and allowing user to remove food canister 15 while maintaining a grip on food canister 15 through the top cover canister grip surface 13. Top cover lip 14 over hangs the top cover canister grip surface 13 offering a means to additionally grip the top cover 1 and attached food canister 15. Other embodiments of enclosure top cover 1 could combine stiffer materials for structure and flexible materials for gripping and stretching. Examples might be a harder plastic structure over molded with flexible materials or a stiffer shell attached to a flexible structure.

According to an embodiment of the present invention shown in FIG. 6C another example of the top cover 1 with a top cover inside seal 50 seals on the inside surfaces between side wall 2 and top cover 50 at a top cover inside seal interference 51.

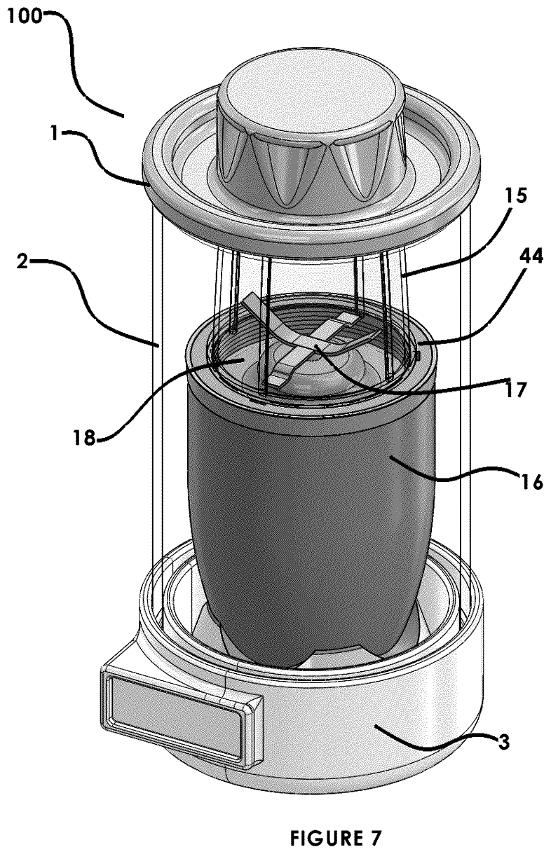

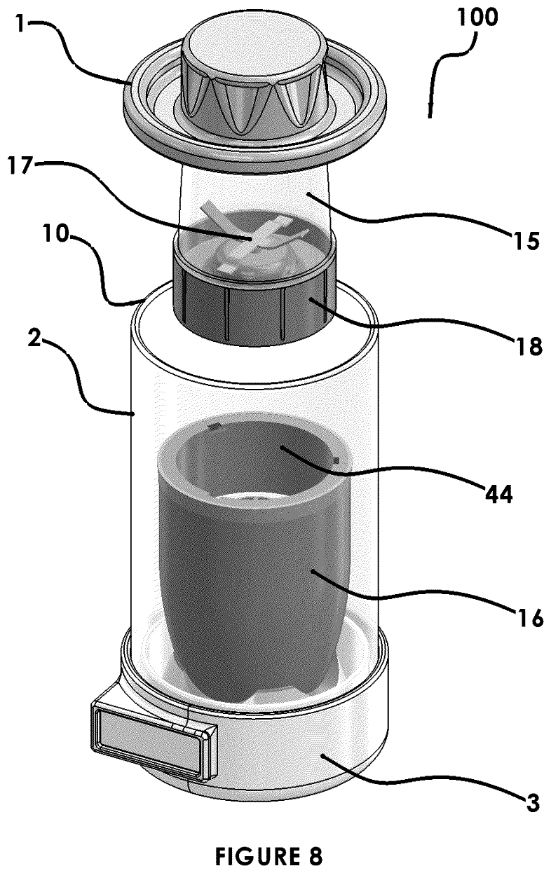

FIGS. 7-8 Gripping the food canister 15 thru the top cover 1 enables the installation of the food canister assembly consisting of food canister 15, chopping knives 17, canister base 18 into a motor drive well 44 of the blender base 16. Some blenders require the user apply constant downward pressure on the canister to keep the blender base powered while other blender models have a locking mechanism whereby depressing the canister assembly into the blender base turns on of the blender motor and a small rotation of the assembly will lock it in place leaving the blender motor running without the user needing to apply downward pressure. To remove the food canister assembly the user grips the food canister 15 through the flexible material top cover 1 and for example turns to unlock maintaining a grip on the food canister 15 through the top cover 1 and removing entire canister assembly.

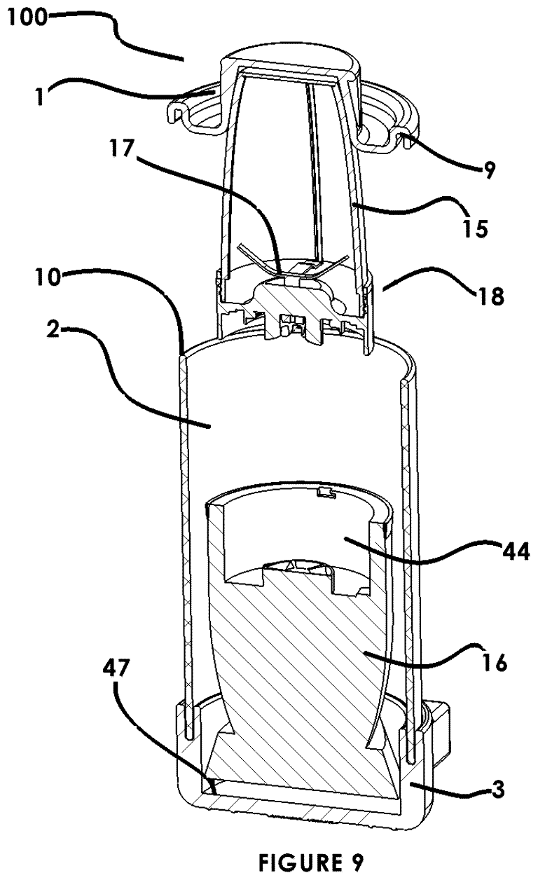

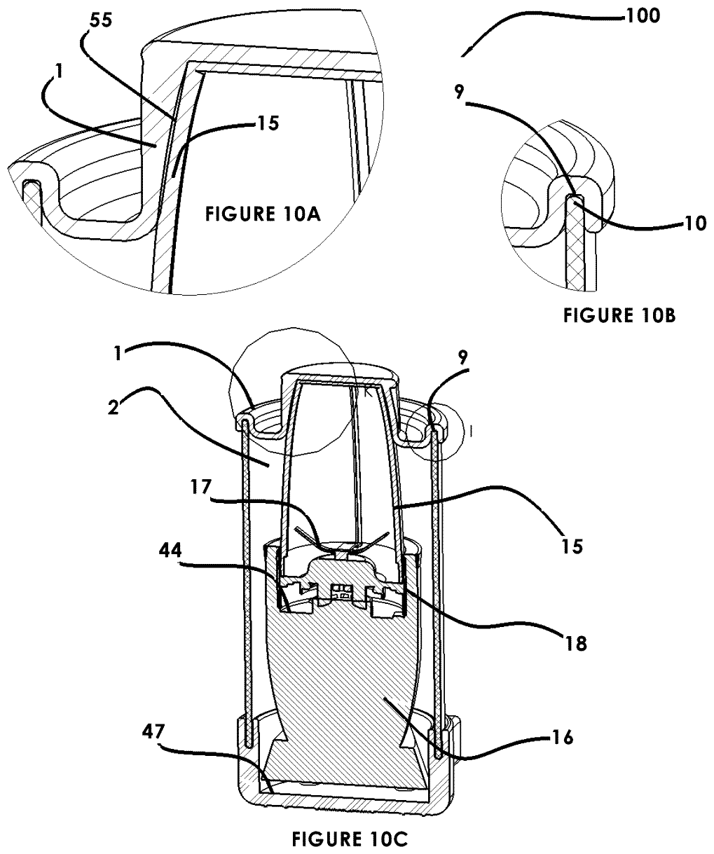

FIG. 9 illustrates blender base 16 positioned on the enclosure base 3 inside bottom surface 47. Top cover 1 grips food canister 15 and the assembly is installed into motor drive well 44 of blender base 16 as shown in FIG. 10C.

A top cover interference fit 55 between top cover 1 and food canister 15 is illustrated in FIG. 10A. Blender food canister assembly consists of a food canister 15, chopping knives 17, and a canister base 18. Installing blender food canister assembly into motor drive well 44 the top cover edge grove 9 of the top cover 1 fits over enclosure side wall 2 side wall top edge 10 as shown in FIG. 10B. The entire assembled unit is shown in FIG. 10C.

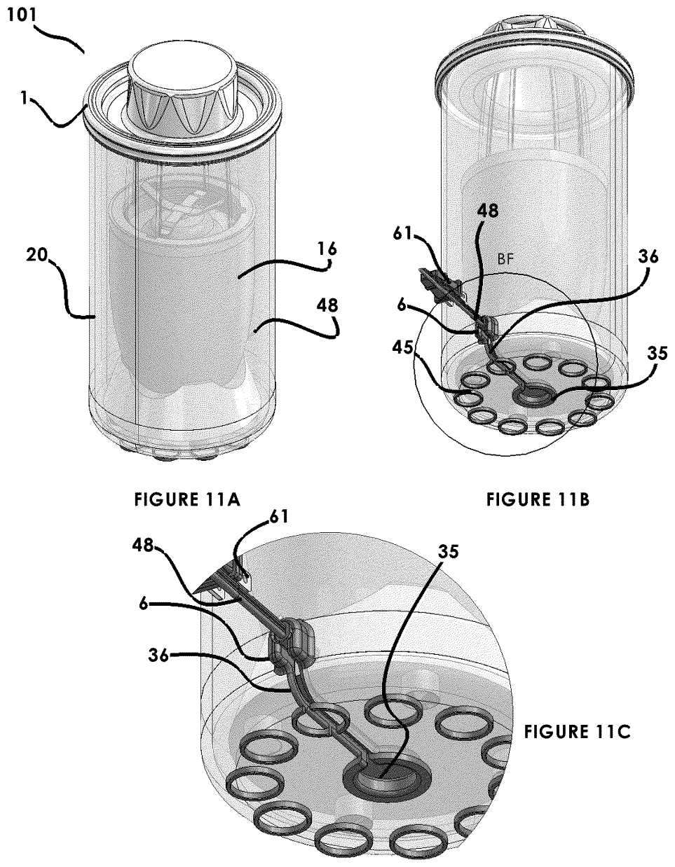

Another embodiment of an enclosure made in accordance with the present invention is show in FIGS. 11A-C and is indicated generally by the numeral 101. Enclosure 101 is identical in most respects to enclosure 100 discussed above and like components will therefore be numbered accordingly.

Enclosure 101 as shown in FIG. 11A is an integrated version of enclosure 100 where side wall 2 and enclosure base 3 of enclosure 100 are combined into a single unit an integrated sides and base 20. In the preferred embodiment integrated sides and base 20 is injection molded, compression molded or cast in clear or translucent materials comprising acrylic, polycarbonate, polyethylene terephthalate, polyvinyl chloride, polypropylene, polystyrene, polymethyl methacrylate, polyamide, ABS, SAN, Polyethylene, and TPU.

FIG. 11B and 11C In the present embodiment AC power plug grommet 35, AC power cord grommet slot 36, and AC power cord pass through 6 are molded into integrated sides and base 20 by means of a plastic injection over molding process. FIG. 11B illustrates a means to route a power cord plug 61 through the interior of integrated sides and base 20 through an AC power plug grommet 35 and pass blender AC power cord 48 through AC power cord grommet slot 36 into blender AC power cord pass through 6. In another embodiment AC power plug grommet 35, AC power cord grommet slot 36, and AC power cord pass through 6 are molded as separate pieces or combinations of separate pieces and installed in integrated sides and base 20. In another embodiment a seal fabricated from various materials comprising rubber, foam, elastomer and shaped to fit into AC power plug grommet 35, AC power cord grommet slot 36, and AC power cord pass through 6 may be placed into these open shapes to block sound. In another embodiment a sealing material comprising rubber, foam, or elastomer is fabricated via injection or compression molding or cut from sheet stock to fit on the inside bottom of integrated sides and base 20 will block sound from escaping AC power plug grommet 35, AC power cord grommet slot 36, and AC power cord pass through 6 but also add to the sound reduction performance of the system by absorbing vibration and sound from electric motor 26.

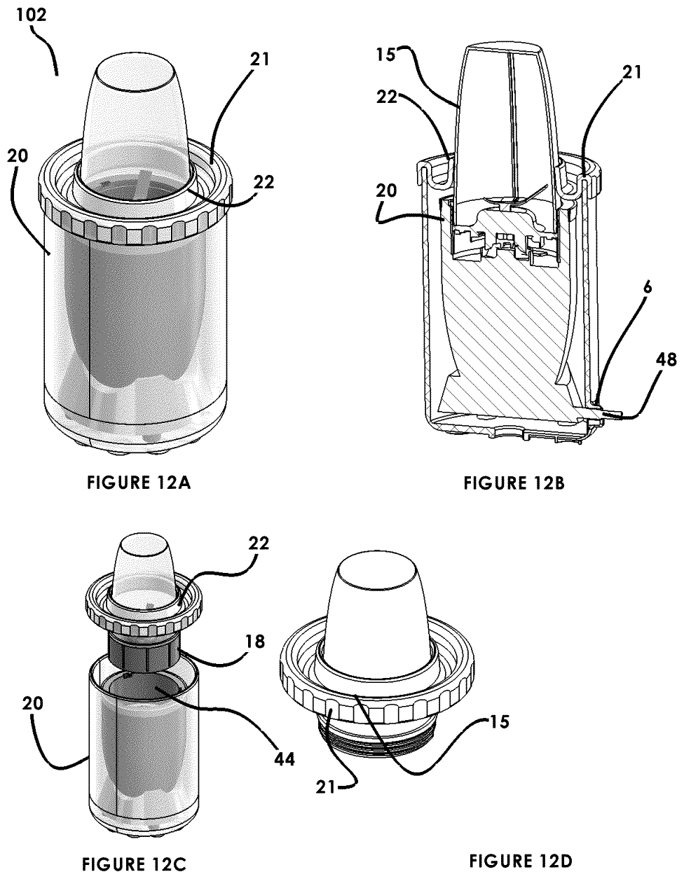

Another embodiment of an enclosure made in accordance with the present invention is show in FIG. 12A and is indicated generally by the numeral 102.

An example with Integrated sides and base 20 with wall height approximately even with the height of the enclosed blender base 16 and utilizing open center top cover 21 with an open center top cover lip 22 through which the blender food canister 15 is positioned is shown in FIG. 12A and FIG. 12B. In a configuration using the integrated side and base 20, an alternative configuration is a shorter side wall 2 attached to an enclosure base 3.

Open center top cover lip 22 of open center top cover 21 is gripped on opposite sides which holds the food canister 15 as shown in FIG. 12B.

As shown in FIG. 12C open center top cover 21 and food canister assembly can be removed as a single unit in much the same manner as with top cover 1 with the food canister 15 being gripped on opposite sides through open center top cover lip 22.

The assembly of open center top cover 21 and food canister 15, removed from canister base 18 can be utilized as an assembly for drinking or pouring with top cover 21 holding drips and providing additional gripping utility as shown in FIG. 12D.

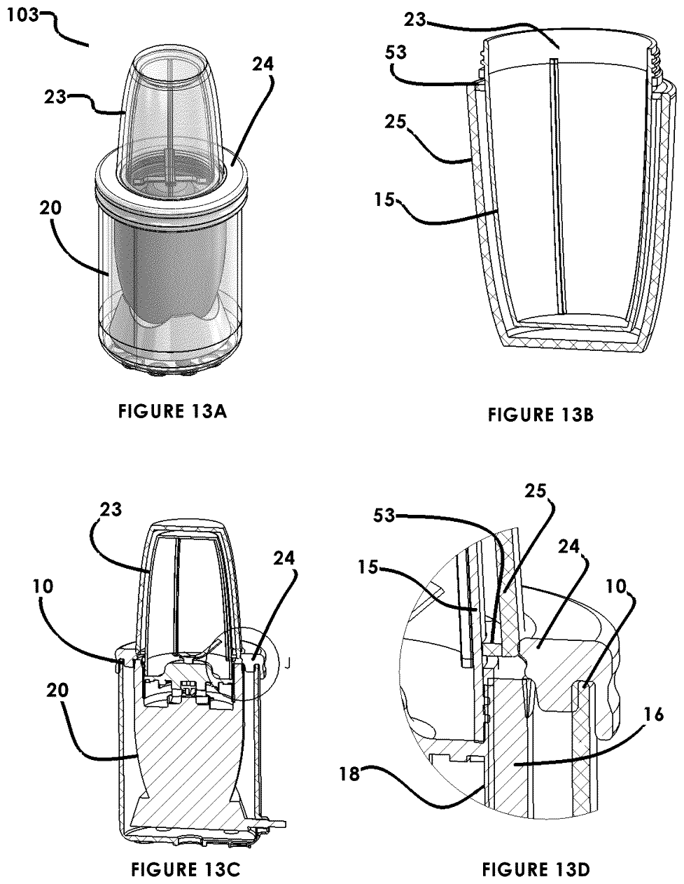

Another embodiment of an enclosure made in accordance with the present invention is show in FIG. 13A and is indicated generally by the numeral 103

FIG. 13A illustrates a sound enclosure configuration which includes an enclosure top gasket 24 permanently affixed on the blender enclosure base 20 on side wall top edge 10. Food canister 15 affixed to canister base 18 is inserted into the motor drive well 44 sealing against the inside edge of enclosure top gasket 24.

Another example uses a double wall food canister assembly 23 in place of food canister 15 as shown in FIG. 13B The double wall structure reduces noise not trapped by a single food container and offering additional user protection where the inner canister shatters or fails. Food canister outer cup 25 is suspended around the food canister 15 and attached at one or more points with double wall seal 53 on the top edge of food canister outer cup 25 as shown in FIG. 13D.

These attachment points may also be positioned in other locations between the two covers. Air or other gas is sealed between food canister 15 and food canister outer cup 25. A partial vacuum may also be utilized offering additional sound reduction.

FIG. 13C and FIG. 13D illustrate the double wall canister assembly 23 sealed on the inside radius of enclosure top gasket 24. The example shown in FIG. 13D illustrates an interference fit between the canister outer wall 25 and inside edge of enclosure top gasket 24.

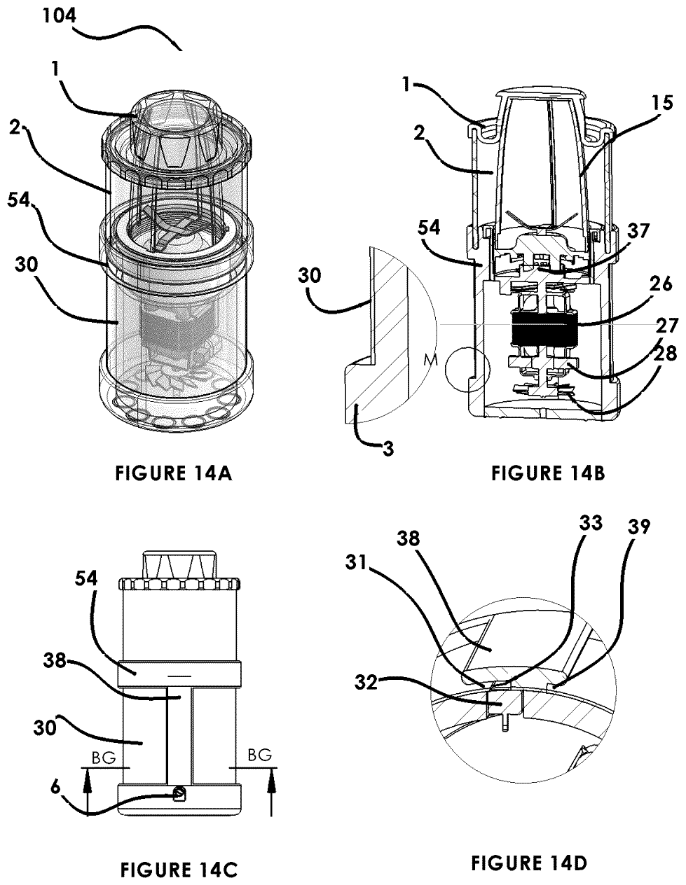

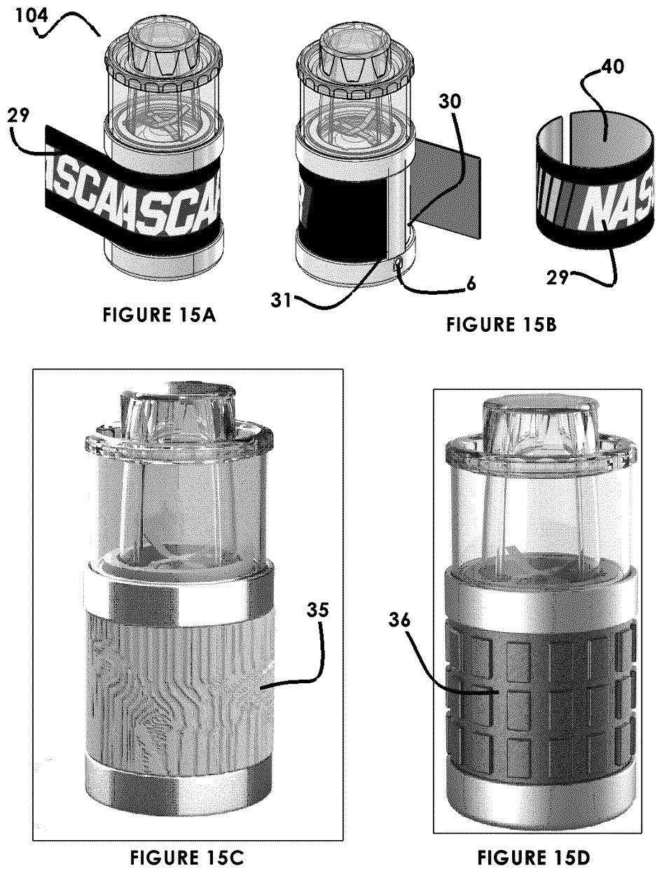

Another embodiment of an enclosure made in accordance with the present invention is shown in FIGS. 14A-14C and FIGS. 15A-15D and is indicated generally by the numeral 104 is an example of the sound and safety enclosure with an integrated blender mechanism contrasted with other embodiments where a stand-alone blender is housed in the sound and safety enclosure. 104 is identical in most respects to enclosure 101 discussed above and like components will therefore be numbered accordingly.

As illustrated in FIG. 14A enclosure 104 includes a top cover 1, side wall 2, blender integrated base 54 and decorative metal cover 30. Decorative metal cover 30 wraps around the center section of blender integrated base 54. Decorative metal cover 30 is made from materials comprising rolled steel, magnetic stainless steel or ferrous materials that will attract a magnet. Non-magnet material with magnetic inserts or other attachment means such a hooked loop material are examples of materials for decorative metal cover 30. This attachment surface enables the user to customize the aesthetic look of a blender enclosure with a decorative wrap 29 which is attached or removed by magnetic or other means. If decorative wrap 29 is not in place the decorative metal cover 30 will satisfy basic esthetics.

FIG. 14B is a cross section of the blender integrated sound enclosure illustrated in FIG. 14A. This example of the present invention integrates main blender components comprising canister blade drive mechanism 37, electric motor 26, motor brushes 27 and air movement fan 28 with the blender integrated base 54 eliminating the separate packaging cost and complexity of the enclosure for a separately manufactured fully enclosed stand-alone blender as shown in FIG. 2B.

FIG. 14C is a rear view of embodiment 102 showing decorative wrap ends cover 38, decorative metal cover 30 and blender power cord pass through 34.

FIG. 14D is a cross section of FIG. 14C illustrating the geometry of the decorative wrap ends cover 38 with a deep slot 31 and a shallow slot 39. Deep slot 31 and shallow slot 39 are formed by the inside face of ends cover 38 and face of enclosure base 54. The decorative wrap 29 is installed by means of sliding one end of the decorative wrap 29 under deep slot 31, wrapping the decorative wrap around the enclosure base and inserting the second end into shallow slot 39.

In another example the deep slot 31 may have an electrical contacts 33 with power and ground connected to low voltage power supply 32. Low voltage power supply 32 supplies current to decorative wrap 29 with LED or electroluminescent lights or other circuitry or battery requiring a power source. A wrap requiring a power source will have exposed conductive ends which are inserted into deep slot 31 making connection with contacts 33 for power and ground but also electrical signals to drive various functions in decorative wrap 29. In another example the decorative wrap 29 would utilize a wound copper coil with matching charging circuitry and coil in the blender integrated base 54 to supply power and signal.

To protect against illegal decorative wraps in another example a proprietary connection pattern specification can be utilized to allow standard conforming wraps to enable the blender mechanism power. Another example would utilize a proprietary code or handshake circuit on the wrap to interface to the main blender circuity for blender motor power connection. The code could be supplied by a conventional RFID tag in the decorative wrap.

FIG. 15A illustrates decorative wrap 29 partially wrapped around decorative metal cover 30. FIG. 15B illustrates the decorative wrap inserted into deep slot 31. The surface of decorative wrap 29 is imprinted with images or patterned with three dimensional structures. In one example this decorative surface will be laminated to a magnetic layer 40 or alternative layer with means to attach to decorative metal cover 30.

FIG. 15C and FIG. 15D illustrate examples of decorative cover 29 molded in various materials comprising rubber, metal or other material to present a pleasing texture and appearance to the user.

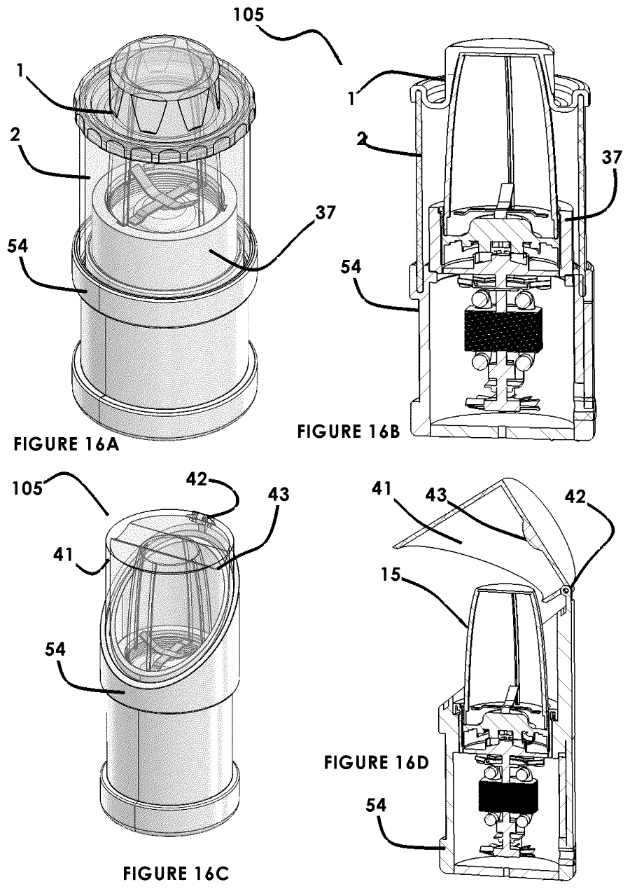

FIG. 16A and FIG. 16B show an example of the blender enclosure base 54 being of reduced height exposing a greater view of the main blender canister blade drive mechanism 37, a longer side wall 2 offering a larger viewing area over that shown in FIG. 14A.

Another embodiment of an enclosure made in accordance with the present invention is show in FIG. 16C-16D and is indicated generally by the numeral 105.

FIG. 16C illustrates embodiment 105 with blender integrated base 54 extended to the full height of the blender assembly with the top face removed on a diagonal exposing the food canister 15 and with a hinge 42 integrated at the top rear surface of blender integrated base 54. A wedge cover 41 is attached to the blender integrated base hinge allowing wedge cover 41 to pivot up allowing the food canister 15 assembly to be removed. As shown in FIG. 16D when the wedge cover 41 is closed canister contact 43 presses down on the top surface of food canister 15 starting the blender motor. When wedge cover 41 is pivoted up canister contact 43 releases pressure on food canister 15 stopping the blender motor. Canister contact 43 may take many forms comprising a molded rounded shape or attached pad manufactured from materials including rubber, elastomer, metal, or plastic.

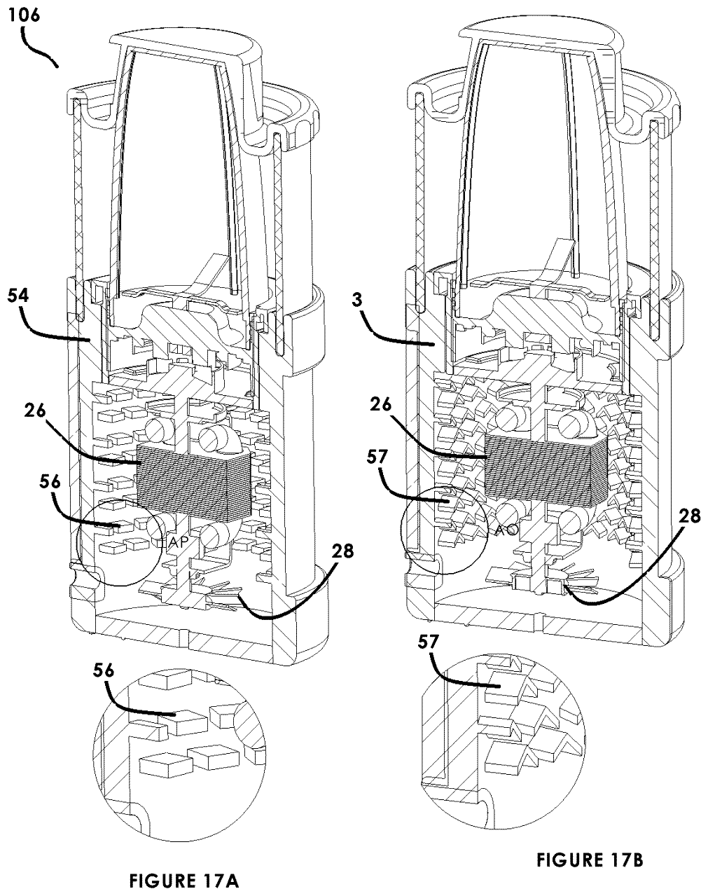

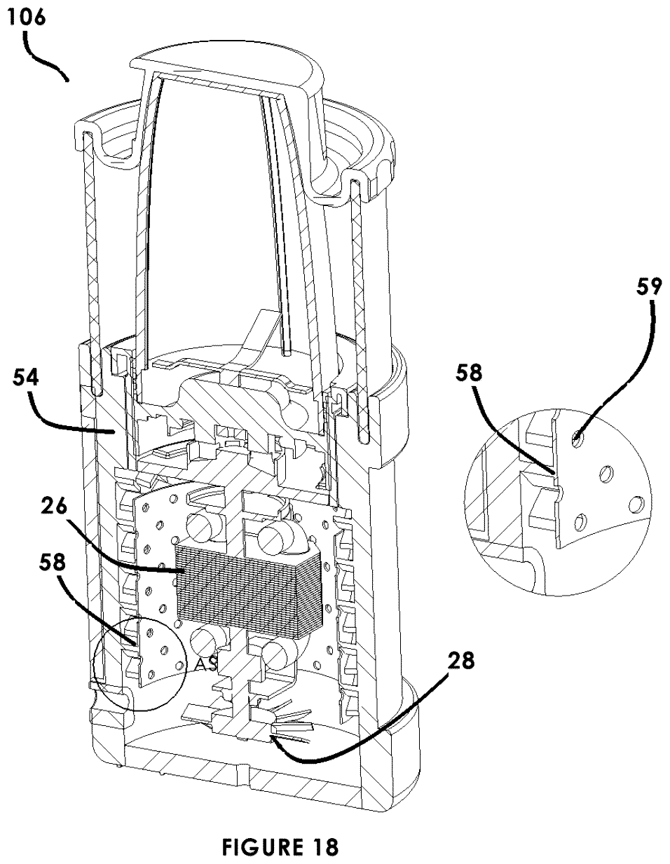

Another embodiment of an enclosure made in accordance with the present invention is show in FIG. 17A and is indicated generally by the numeral 106 with blender integrated base 54 with internal sound baffle structures utilizing a sound baffle fin 56 arranged around the inside circumference and stacked in layers to the bottom of the enclosure. The purpose of interior cavities with sound baffle fin 56 is to interrupt the air flow and noise from air movement fan 28 causing destructive interference of the acoustic waves and reducing noise. In addition, these fins also increase the surface area of the enclosure interior thus absorbing additional heat generated by electric motor 26. FIG. 17B illustrates an example of enclosure base 3 with internal sound baffle structures utilizing a sound baffle hat 57 arranged around the inside circumference and stacked in layers to the bottom interior of enclosure base 54. The arrangement and shape of these baffles is matched to the frequency spectrum and power spectrum characteristics of an individual blender motor and enclosure assembly. FIG. 18 illustrates an example of blender integrated base 54 with internal sound baffle structures for example utilizing a sound baffle hat 57 arranged around the inside circumference and stacked in layers to the bottom of the enclosure with sound baffle perforated cover 58 affixed to the interior faces of the array of sound baffle hat 57. Baffle perforated cover 58 is penetrated by an array of a tuned perforation port 59 holes which enhances the sound reduction performance of the baffle fin structures. Baffle perforated cover 58 also absorbs heat from air moved by air movement fan 28 over electric motor 26.

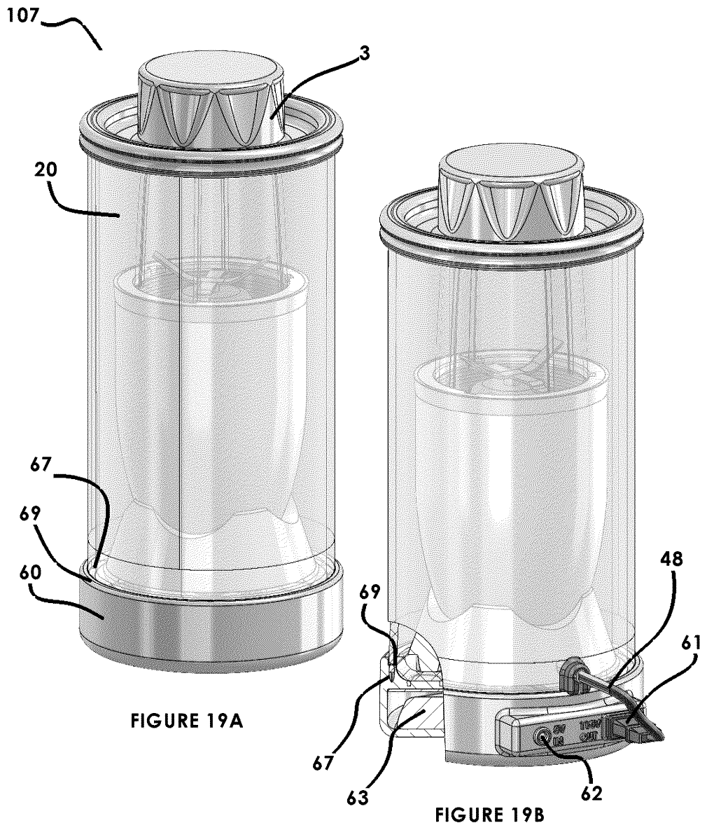

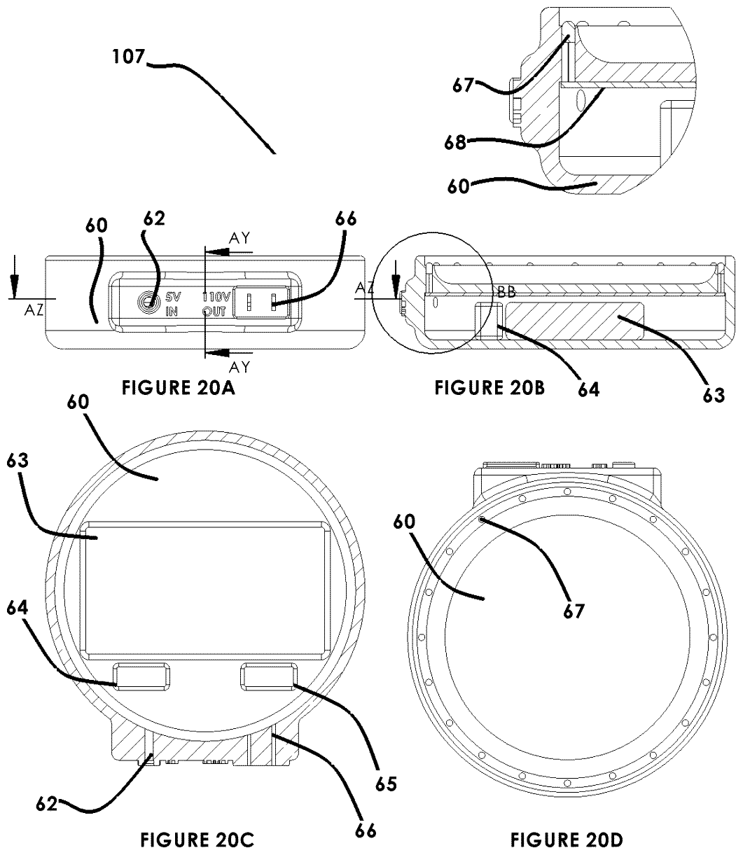

Another embodiment of an enclosure made in accordance with the present invention is show in FIG. 19A-B, FIG. 20A-D and is indicated generally by the numeral 107

FIG. 19A illustrates an exploded view of integrated sides and base 20 and a battery power unit 60 which stores energy enabling the blender unit to operate without conventionally provided AC power. Battery power unit 60 also may contain electronics comprising voltage regulators, processors, proximity sensors, to drive light sources 67 which illuminate the integrated sides and base 20 by directing light into light pipe step 69 as shown in the cut away in FIG. 19B.

Integrated sides and base 20 and battery power unit 60 may be connected by numerous means comprising a friction fit, hooked loop system or screw on fit between integrated sides and base 20 and battery power unit 60. Another embodiment would integrate the function and connections of battery power unit 60 into the base of integrated sides and base 20.

FIG. 20A is a rear view of battery power unit 60 with charger input 62 which is supplied current from a separate DC charger. A high AC voltage socket 66 receives the power cord plug 61 to supply voltage to the blender unit when conventional AC power is not available. FIG. 20B is a cross section of FIG. 20A illustrating light source 67 in this example connected to printed circuit board 68. FIG. 20C is a horizontal cross section of battery power unit 60 showing a rechargeable battery 63 which for example could be lithium-ion or other suitable rechargeable technology, a charging controller 64 which monitors battery temperature and controls rate of battery charge from charger input 62, a high voltage inverter 65 which converts battery power to AC power for instance 110 volts or 220 volts. AC power is distributed from high voltage inverter 65 through high AC voltage socket 66.

FIG. 20D is a top view of battery power unit 60 showing an example array of 20 light source 67. Light sources may comprise electroluminescent, LED, and incandescent. A configuration of battery power unit 60 could be adapted for embodiment 104 for instance as an attachment for example shown in embodiment 107 or with full battery power unit 60 included functionality and connectivity.

What I am claiming is:

1. A sealed soundproof enclosure for a food blender that reduces the noise level of said food blender during operation, said enclosure comprising:
an enclosure base with an enclosure base slot;
side walls inserted into said enclosure base slot, wherein said enclosure base slot receives side wall bottom edge, wherein width of said enclosure base slot widens as said side wall bottom edge is received enabling an air and noise seal; and
a top cover, wherein a top cover edge groove seals against a side wall top edge minimizing the movement of air between an enclosure interior and an enclosure exterior in order to reduce sound, wherein a top cover center section stretches over an end of a food canister that allows user to grip said food canister through a flexible material for efficient insertion and removal in addition to pressing said food canister down into a blender base to start a blender motor.

2. The enclosure of claim 1, wherein said enclosure base comprises an opening through which a blender AC power cord passes.

3. The enclosure of claim 1, wherein said enclosure base comprises a cord relief slot configured to spread open as said blender AC power cord is being pressed in a downward direction from an enclosure base top edge towards said opening, once said blender AC power cord is captured by said opening, said cord relief slot will return to a closed position enhancing the air and noise seal.

4. The enclosure of claim 1, wherein a side wall top edge and a side wall bottom edge of said side wall are rounded or beveled to enhance sealing efficiency between said top cover and said enclosure base.

5. The enclosure of claim 1, wherein said side walls may comprise two or more layers of material with air gaps between said layers to offer additional sound damping.

6. The enclosure of claim 1, wherein said top cover may be provided with a top cover inside seal that seals on the inside surfaces between said side walls and said top cover at a top cover inside seal interference.

7. A sealed soundproof enclosure for a food blender that reduces the noise level of said food blender during operation, said enclosure comprising:
an enclosure base molded with an integrated side walls to form a single unit, said single unit including an AC power plug grommet in bottom, an AC power cord grommet slot leading from said AC power plug grommet towards a rear side to an opening to pass an AC power cord therethrough;
a top cover, wherein a top cover edge groove seals against a side wall top edge minimizing the movement of air between an enclosure interior and an enclosure exterior in order to reduce sound, wherein a top cover center section stretches over an end of a food canister that allows user to grip said food canister through a flexible material for efficient insertion and removal in addition to pressing said food canister down into a blender base to start a blender motor.

8. The enclosure of claim 7, wherein said AC power plug grommet, said AC power cord grommet slot, and said opening are molded as separate pieces or combinations of separate pieces and installed in said single unit.

9. The enclosure of claim 7, wherein a seal is fabricated from various materials comprising rubber, foam, elastomer and shaped to fit into said AC power plug grommet, said AC power cord grommet slot, and said opening to block sound.

10. The enclosure of claim 7, wherein a sealing material comprising rubber, foam, or elastomer is fabricated via injection or compression molding or cut from sheet stock to fit on the inside bottom of said single unit to block sound from escaping said AC power plug grommet, said AC power cord grommet slot, and said opening, and also add to the sound reduction performance of the system by absorbing vibration and sound from an electric motor.

11. The enclosure of claim 7, wherein said single unit may have a wall height approximately even with height of an enclosed blender base.

12. The enclosure of claim 11, may comprise an open center top cover with an open center top cover lip through which said food canister is positioned, said open center top cover lip is gripped on opposite sides which holds and seals said food canister, wherein said open center top cover and said food canister can be removed altogether.

13. The enclosure of claim 7, wherein said single unit may optionally comprises a battery power unit to store energy enabling a blender unit to operate when AC power is not available, said battery power unit includes electronics comprising voltage regulators, processors, and proximity sensors to drive an array of light sources that illuminate said single unit by directing light into a light pipe step.

14. The enclosure of claim 13, wherein said battery power unit is connected with said single unit by a friction fit, a hooked loop system or screw on fit therebetween.

15. The enclosure of claim 13, wherein said battery power unit comprises: a rechargeable battery which is charged via a charger input, a charging controller which monitors battery temperature and controls rate of battery charge from said charger input, and a high voltage inverter which converts battery power to AC power.

16. The enclosure of claim 13, wherein said battery power unit comprises a high AC voltage socket that receives a power cord plug to supply voltage to said blender unit when conventional AC power is not available.

17. The enclosure of claim 13, wherein said array of light source is connected to a printed circuit board, said light sources may comprise electroluminescent, LED, and incandescent.

18. A sealed soundproof enclosure with an integrated blender mechanism that reduces the noise level of blender assembly during operation, said enclosure comprising:
a blender integrated base molded with side walls, said blender integrated base including an AC power plug grommet in bottom, an AC power cord grommet slot leading from said AC power plug grommet towards a rear side to an opening to pass an AC power cord therethrough;
a top cover, wherein a top cover edge groove seals against a side wall top edge minimizing the movement of air between an enclosure interior and an enclosure exterior in order to reduce sound, wherein a top cover center section stretches over an end of a food canister that allows user to grip said food canister through a flexible material for efficient insertion and removal in addition to pressing said food canister down into a blender base to start a blender motor;
a decorative metal cover is configured to wrap around center section of said blender integrated base, said decorative metal cover including an attachment surface that enables the user to customize an aesthetic look of said enclosure with a decorative wrap which is attached or removed by magnetic or other means, and a decorative wrap ends cover with a deep slot and a shallow slot formed under said decorative wrap ends cover.

19. The enclosure of claim 18, wherein said blender integrated base encloses a canister blade drive mechanism, an electric motor, motor brushes, and air movement fan.

20. The enclosure of claim 18, wherein said blender integrated base may be provided with internal sound baffle structures utilizing a plurality of sound baffle fins arranged around inside circumference and stacked in layers through a bottom of said enclosure, said sound baffle fins interrupt the air flow and noise from an air movement fan causing destructive interference of the acoustic waves and reducing noise, said sound baffle fins increase the surface area of said enclosure interior thus absorbing additional heat generated by an electric motor.

21. The enclosure of claim 20, wherein said sound baffle structures may utilize a plurality of sound baffle hats.

22. The enclosure of claim 20, wherein said sound baffle structures may be provided with a sound baffle perforated cover affixed to interior faces of the array of said sound baffle structures, said sound baffle perforated cover is penetrated by an array of a tuned perforation port holes which enhances the sound reduction performance of said sound baffle structures, and also absorbs heat from air moved by said air movement fan over said electric motor.

23. The enclosure of claim 18, wherein said decorative wrap is installed by means of sliding one end of said decorative wrap under said deep slot, wrapping said decorative wrap around said blender integrated base, and inserting the second end into said shallow slot.

24. The enclosure of claim 18, wherein said deep slot may have an electrical contact with power and ground connected to low voltage power supply, wherein said low voltage power supply supplies current to said decorative wrap with LED or electroluminescent lights or other circuitry or battery requiring a power source.

25. The enclosure of claim 18, wherein said decorative metal cover is made from materials comprising rolled steel, magnetic stainless steel or ferrous materials, non-magnetic material with magnetic inserts or hooked loop material.

26. The enclosure of claim 18, wherein said decorative wrap is molded in various materials comprising rubber, metal, or other material to present a pleasing texture and appearance to the user.

27. A sealed soundproof enclosure with an integrated blender mechanism that reduces the noise level of blender assembly during operation, said enclosure comprising:
a blender integrated base extended to a full height of a blender assembly with a top face removed on a diagonal exposing a food canister, wherein a hinge is integrated at a top rear surface of said blender integrated base;
a wedge cover is attached to said blender integrated base via said hinge, said wedge cover pivots up to allow said food canister to be removed, and vice versa, wherein said wedge cover including a canister contact thereunder to press down on a top surface of said food canister to start a blender motor, and vice versa.

28. The enclosure of claim 27, wherein said canister contact may take many forms comprising a molded rounded shape or attached pad manufactured from materials including rubber, elastomer, metal, or plastic.
